(19) United States
(12) Patent Application Publication
(10) Pub. No.: US 2015/0304745 A1
(43) Pub. Date: Oct. 22, 2015

(54) A SOUND PRODUCING VIBRATING SURFACE

(71) Applicant: NOKIA CORPORATION, Espoo (FI)

(72) Inventors: Andreas FROMEL, Kirchseeon (DE); Klaus GEBERT, Rettenbach (DE)

(21) Appl. No.: 14/383,747

(22) PCT Filed: Mar. 16, 2012
(86) PCT No.: PCT/IB2012/051286

§ 371 Date: Jan. 25, 2015

(51) Int. Cl. H04R 1/00; H04R 17/00

(52) U.S. Cl. CPC H04R 1/00; H04R 17/00

(57) ABSTRACT

An apparatus comprising: a transducer configured to mechanically vibrate; and a surface coupled to the transducer, wherein the surface is configured to receive the mechanical vibrations from the transducer, permit the vibration to pass through the surface whilst remaining substantially static, and such that in use the surface generates audible vibrations where the vibrations exit the surface and the surface is positioned proximate to an users ear.

### FIELD

The present application relates to an earpiece vibra, and in particular, but not exclusively to an earpiece vibra for use in portable apparatus.

### BACKGROUND

The use of electro-dynamic loudspeakers or earpiece units in apparatus is common. Most electronic devices contain an electro dynamic loudspeaker or transducer configured to convert electrical signals into acoustic waves to be output and heard by the user of the apparatus. For example mobile or similar telephones can contain an integrated transducer sometimes called an integrated handsfree (IHF) transducer configured to operate as an earpiece for speech and also as a loudspeaker for hands free and audio signal playback.

Modern electronic devices or apparatus are designed with feature displays which attempt to use as much of the available area on the service, in other words to attempt to reduce the overall size of the apparatus to that of the display. The distance between the display edge and an upper edge of the apparatus is therefore small and getting smaller. For example as shown on FIG. 2 the electronic apparatus or device 10 has a display 101 which is configured to use as much space as possible such that the distance between the display edge and the “upper edge” of the mobile phone 107 is very small. Furthermore within this dimension or display surround region 103 the earpiece hole 105 has to be located and underneath the earpiece hole 105 has to be implemented the earpiece transducer.

### SUMMARY

Embodiments attempt to address the above problem.

There is provided according to a first aspect an apparatus comprising: a transducer configured to mechanically vibrate; and a surface coupled to the transducer, wherein the surface is configured to receive the mechanical vibrations from the transducer, permit the vibration to pass through the surface whilst remaining substantially static, and such that in use the surface generates audible vibrations where the vibrations exit the surface and the surface is positioned proximate to an users ear.

The apparatus may further comprise: a sensor configured to determine a proximate object to the surface; and a controller configured to select the transducer when the sensor determines the proximate object.

The apparatus may further comprise a hands free transducer, wherein the controller is configured to select the hands free transducer on the sensor failing to determine a proximate object.

The transducer may be at least one of: a linear vibra; an eccentric mass vibra; a piezoelectric vibra; and a moving magnet transducer.

The linear vibra may comprise: a magnet; a mass coupled to the magnet; a resilient member coupled to at least one of the magnet and mass, wherein the resilient member is configured to constrain the movement of the magnet and mass in a linear manner; and a coil configured to receive an input and drive the magnet and mass to produce the audible vibrations.

The transducer may be coupled to the surface via at least one of: a direct coupling; and an intermediate coupling configured to transmit the audible vibration from the transducer to the surface.

The surface may comprise at least one of: a display panel; touch screen display panel; a casing; and a housing.

The transducer may be coupled to the display panel substantially along the mid line of the width of the display panel.

The transducer may be coupled to the display panel substantially to one edge of the length of the display panel.

The audible vibrations may simulate the output of an earpiece module.

According to a second aspect there is provided a method comprising: mechanically vibrating a transducer; coupling a surface to the transducer; passing the vibration through the surface while the surface remaining substantially static; and positioning the surface proximate to an users ear so that the surface generates audible vibrations where the vibrations exit the surface.

The method may further comprise: determining a proximate object to the display; and selecting the transducer to generate mechanical vibrations when the sensor determines the proximate object.

The surface may comprise at least one of: a display panel; touch screen display panel; a casing; and a housing.

Coupling the transducer to the display panel may comprise coupling the transducer to the display panel substantially along the mid line of the width of the display panel.

Coupling the transducer to the display panel may comprise coupling the transducer to the display panel substantially to one edge of the length of the display panel.

The method may simulate an output of an earpiece module.

According to a third aspect there is provided an apparatus comprising: means for mechanically vibrating; and means for covering configured to receive the mechanical vibrations, permit the vibrations to pass through the means for covering whilst remaining substantially static, and such that in use the means for covering generates audible vibrations where the vibrations exit the means for covering positioned proximate to an users ear.

The apparatus may further comprise: means for determining a proximate object to the means for covering; and means for selecting the means for mechanically vibrating when the means for determining determines the proximate object.

The apparatus may further comprise means for mechanically vibrating, wherein the means for selecting is configured to select the means for mechanically vibrating on the means for determining failing to determine a proximate object.

The means for mechanically vibrating may be at least one of: a linear vibra; an eccentric mass vibra; a piezoelectric vibra; and a moving magnet transducer.

The linear vibra may comprise: a magnet; a mass coupled to the magnet; a resilient member coupled to at least one of the magnet and mass, wherein the resilient member is configured to constrain the movement of the magnet and mass in a linear manner; and a coil configured to receive an input and drive the magnet and mass to produce the audible vibrations.

The means for covering may comprise at least one of: a display panel; touch screen display panel; a casing; and a housing.

The means for mechanically vibrating may be coupled to the display panel substantially along the mid line of the width of the display panel.

The means for mechanically vibrating may be coupled to the display panel substantially to one edge of the length of the display panel.

The audible vibrations may simulate the output of an earpiece module.

An electronic device may comprise apparatus as described above.

A chipset may comprise apparatus as described above.

### BRIEF DESCRIPTION OF DRAWINGS

For better understanding of the present invention, reference will now be made by way of example to the accompanying drawings in which:

FIG. 1 shows schematically an electronic device employing some embodiments of the application;

FIG. 2 shows schematically an upper edge view of a typical mobile apparatus;

FIG. 3 shows schematically an example earpiece vibra configuration within an apparatus according to some embodiments;

FIG. 4 shows schematically an example linear vibra according to some embodiments; and

FIG. 5 shows an example of the operation of the linear vibra according to some embodiments.

### DESCRIPTION OF SOME EMBODIMENTS

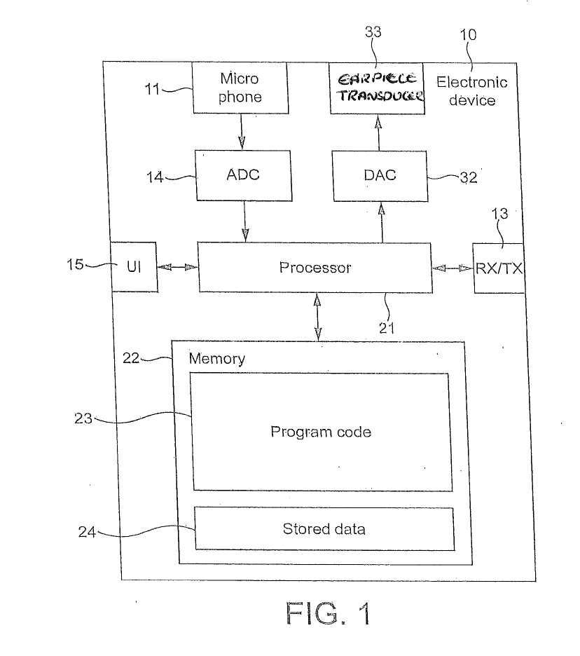

The following describes in more detail possible audio transducers for use in earpiece or speech reproduction audio for the provision of higher quality earpiece or voice communication. In this regard reference is first made to FIG. 1 which shows a schematic block diagram of an exemplary electronic device or apparatus 10, which may incorporate an enhanced audio transducer apparatus according to some embodiments.

The apparatus 10 may for example, as described herein be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

In some embodiments the apparatus 10 comprises a processor 21. Furthermore in some embodiments the apparatus 10 comprises a memory 22, and further a data storage section 24 and program code section 23. The processor 21 can in some embodiments be configured to execute various program codes. The implemented program codes in some embodiments comprise audio signal routing code as described herein. The implemented program codes 23 can in some embodiments be stored for example in the memory 22 for retrieval by the processor 21 whenever needed. The memory 22 could further provide a section 24 for storing data.

The audio signal routing code in some embodiments can be implemented in hardware or firmware.

In some embodiments the apparatus 10 comprises a user interface 15. The user interface 15 enables a user to input commands to the electronic device 10, for example via a touch screen configured to provide both input and output functions for the user interface.

The apparatus 10 in some embodiments comprises a transceiver 13 suitable for enabling communication with other apparatus, for example via a wireless communication network.

A user of the apparatus 10 for example can use the microphone 11 for inputting speech or other audio signals that are to be transmitted to some other apparatus or that are to be stored in the data section 24 of the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

The processor 21 in such embodiments then processes the digital audio signal according to any suitable encoding process, for example a suitable adaptable multi-rate (AMR) coding or codec.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute decoding program code stored in the memory 22. The processor 21 in such embodiments decodes the received data. Furthermore the processor 21 in some embodiments can be configured to output to a digital-to-analogue converter 32. The digital-to-analogue converter 32 converts the signal into analogue audio data and can in some embodiments output the analogue audio via the enhanced earpiece transducer 33 as described herein. Execution of the transducer activation in some embodiments can be triggered by an application called by the user via the user interface 15.

The received encoded data in some embodiments can also be stored instead of an immediate presentation via the transducer 33 in the data section 24 of the memory 22, for instance for later decoding and presentation.

It is to be understood again that the structure of the apparatus 10 could be supplemented and varied in many ways.

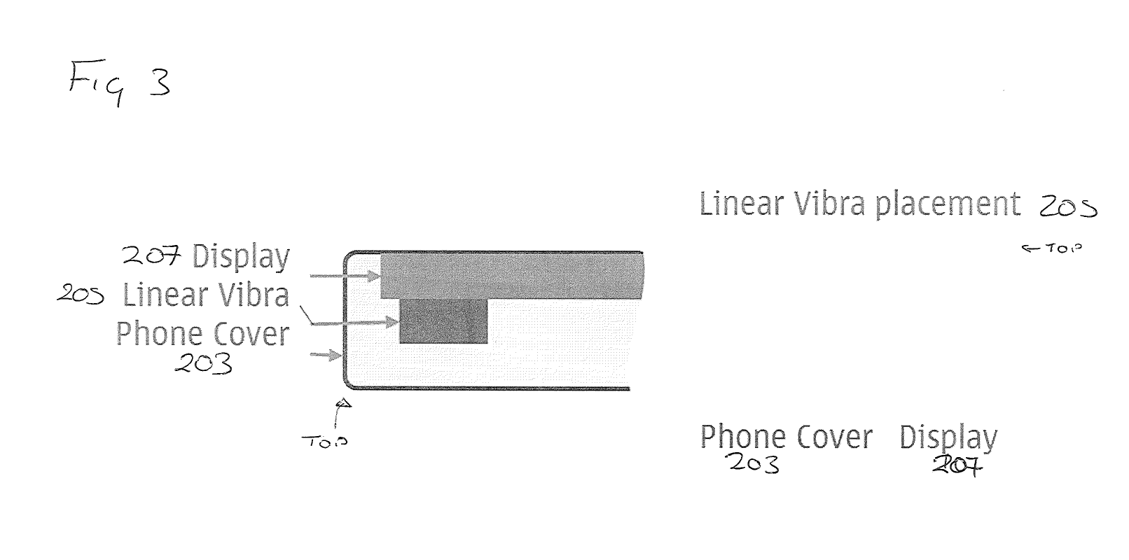

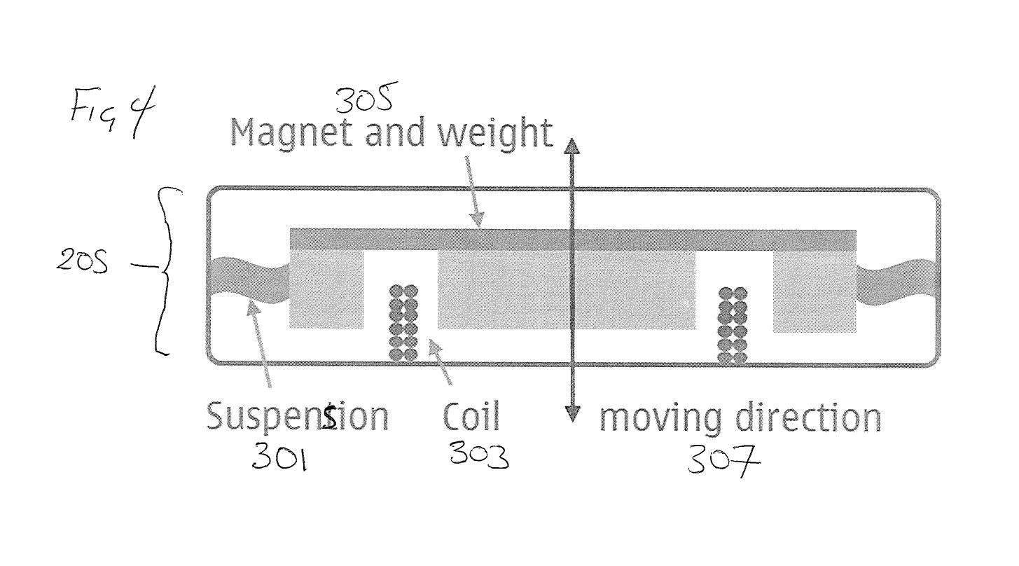

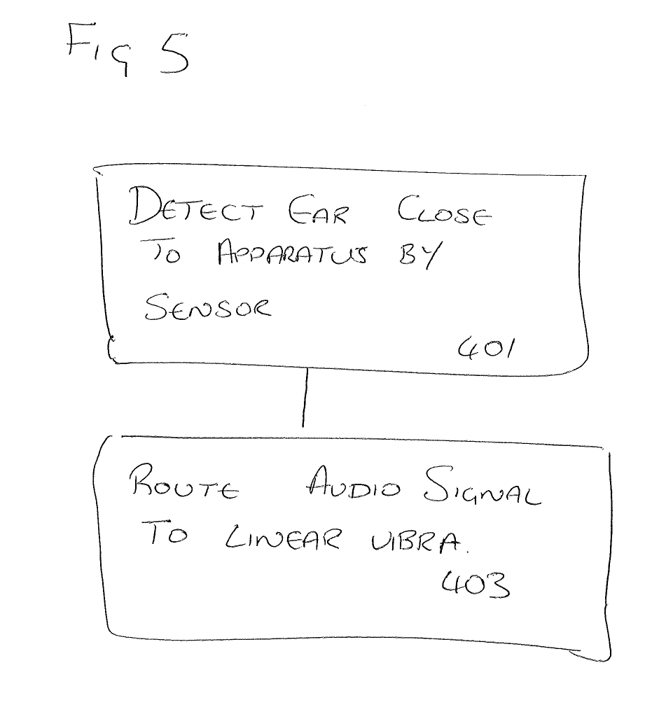

It would be appreciated that the schematic structures described in FIGS. 3 to 4 and the method steps shown in FIG. 5 represent only a part of the operation of audio signal playback apparatus and specifically as exemplarily shown apparatus shown in FIG. 1.

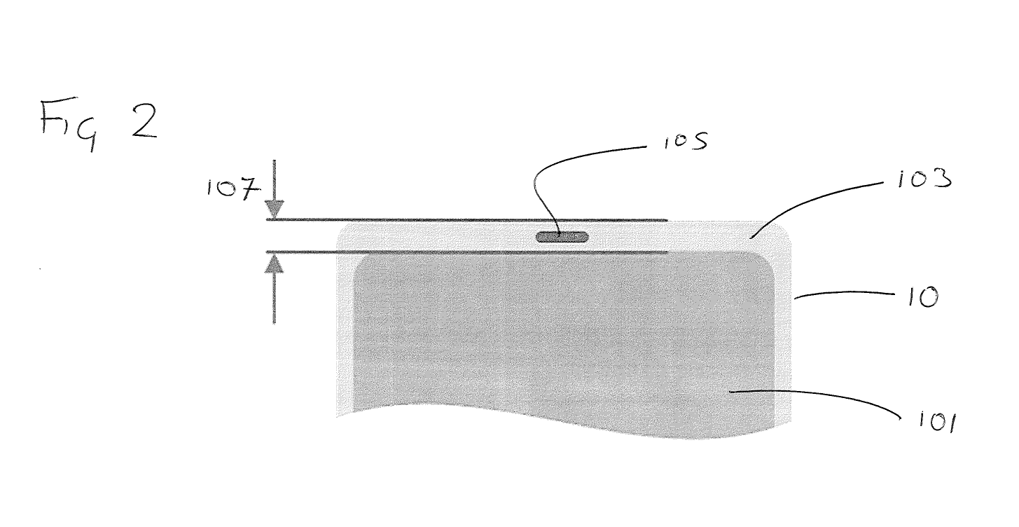

The concept of the application is to improve upon the earpiece implementations currently being designed. As discussed herein and as shown in FIG. 2 the current mobile apparatus and mobile phone designs are such that the display 101, designed to be as large as possible for the apparatus form factor permits an earpiece implementation distance 107 within which the earpiece hole 105 can be located within the display surround or bezel 103 between the display 101 edge and the upper edge of the apparatus 10 is getting smaller and smaller. Due to this it has become difficult to produce a good quality earpiece implementation. The earpiece furthermore typically has to share this space with the display driver and connections.

Furthermore due to the small surround dimension 107 the user of the apparatus can usually not seal the earpiece hole 105 at the edge of the apparatus to their ear. An imprecise seal produces a poor quality earpiece audio performance as it is difficult to seal against background noise and therefore the sound quality of the audio signal is reduced.

Although a singing display, in other words a display attached with suspension to the outer cover being driven by transducers by an audio signal causing the display surface to produce sound or acoustic waves can produce acceptable integrated handsfree operation there can be issues as the user places or locates the ear against the surface as the dampening effect of the body part against the surface can cause the audio signal quality to deteriorate. Furthermore such singing display implementations are typically complex and therefore can have high costs associated with them.

The concept as implemented in embodiments as described herein is to implement a linear vibra module coupled to the display and therefore mounted within the apparatus. When the apparatus determines that the user has placed their ear (or other body part) against the apparatus (for example placing the ear at the “top” of the mobile phone) then the linear vibra transforms the speech audio signal into vibrations, which can pass through the display and be heard by the user. The vibra or any mechanically vibrating means are configured to be coupled to the surface or any suitable means for covering the apparatus. This coupling is such that when in use the vibrations generated in the vibra pass through the surface without significantly moving the surface and when the user of the apparatus places their ear proximate to the surface then the vibrations exit the surface generating audible vibrations which in some embodiments can be used to simulate an earpiece.

In the following examples the surface is the display part, such as a touch screen or touch display panel, of the apparatus. It would be understood that any suitable surface, for example the casing or housing of the apparatus, can similarly be vibrated while maintaining the surface as a whole substantially static.

Furthermore in some embodiments the placement or proximity of the ear to the surface can be considered to generate a partially sealed volume which acts a suitable acoustic focus for the vibrations from the vibra, which pass through the surface and exit the surface within the partially sealed volume.

With respect to FIG. 3 an example implementation of the linear vibra location according to some embodiments is shown. The left hand side of FIG. 3 shows a sectioned view from the top example of the apparatus down through the apparatus, and the right hand side of FIG. 3 shows a “front” view of the “top” of the apparatus (similar to the “top” view as shown in FIG. 2 for the typical mobile phone apparatus) is shown.

The sectioned view of FIG. 3 shows the apparatus or phone cover 203, to the “front” of the apparatus is shown the display 207. The display in some embodiments is rigidly mounted on the casing.

Within the apparatus and attached or coupled to the display 207 is the linear vibra 205. The linear vibra 205 can be located approximately at the position where the ear of the user would be located when holding the apparatus normally.

Thus as shown on the right hand side of FIG. 3 the linear vibra placement 205 is approximately (or substantially) along the middle line of the front of the mobile phone or apparatus and substantially to one side or edge of the longest side of the display 207. It would be understood that in some embodiments the linear vibra can be located at any suitable position providing the linear vibra output is able to generate an acoustic wave listenable by the user when the user places their ear against the surface of the apparatus, and specifically the apparatus display 207.

With respect to FIG. 4 an example linear vibra is shown. The linear vibra 205 can in some embodiments comprise a magnet and weight 305 configured to move substantially linearly because of the suspension 301 attaching the magnet and weight 305 to the edges of the linear vibra 205. The suspension 301 can be any suitable suspension or resilient member flexible enough to allow the magnet and weight 305 to move but sufficiently resilient to allow the magnet and weight 305 to move in an approximately or substantially linear manner as shown in the moving direction 307 as shown in FIG. 4.

In some embodiments the linear vibra comprises a coil 303 configured to receive an electrical audio signal to power the motion of the magnet and weight 305 and generate the vibration configured to be transmitted through the display and generate the acoustic wave heard by the user.

With respect to FIG. 5 the operation of the apparatus is described with further detail. It would be understood that in some embodiments the apparatus can detect when the ear (or user's body part) is close to the apparatus. In some embodiments the detection can be due to the display being a touch screen display. In some embodiments the touch screen display and processor can be configured to determine the difference between an ear and other body part.

In some embodiments the apparatus can comprise any suitable sensor configured to detect the proximity of the user to the display. For example the sensor can be a photo detector or similar configured to detect when the light levels at the front of the apparatus have decreased sufficiently indicating that the apparatus is being held close to the user and therefore in shadow. In some embodiments the apparatus, configured with a singing display can determine when the display is experiencing dampening due to the ear being placed against it.

The operation of detecting the ear close to the apparatus is shown in FIG. 5 by step 401.

In some embodiments the processor can then route the audio signal to the linear vibra in order that the apparatus generates a suitable earpiece audio signal.

The operation of routing the audio signal to the linear vibra is shown in FIG. 5 by step 403.

It would be understood that the linear vibra, is placed below the display with a rigid connection or coupling to the phone cover. As the linear vibra vibrates it produces vibration according to the input audio signal which is transmitted through the display and generating an acoustic wave at the display surface. Thus as soon as the user holds the phone to their ear the vibration is clearly audible on the phone or mobile apparatus surface and the user can listen to the audio signal.

In such embodiments there is no space between the display and casing of the phone required and therefore the display can be as large as needed. Furthermore as no earpiece hole is needed there is no air tight sound channels needed and there is no dust or metal particles which can get into the earpiece through these channels.

Furthermore in such embodiments as the user does not need to place the ear exactly on the earpiece “hole” the user can move the apparatus more freely and still obtain a good quality audio signal.

Furthermore where covers are manufactured from materials such as glass then in some embodiments the apparatus can have a higher reliability as the typical cutting process for cutting earpiece openings causes tensions and weakens the structure of the cover such that there is a lower probability of shattering when dropped. Furthermore as no earpiece mesh needs to be attached and no cutting operations needed then the cost of manufacturing the apparatus cover can be reduced.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-25. (canceled)

26. An apparatus comprising:
a transducer configured to mechanically vibrate; and
a surface coupled to the transducer, wherein the surface is configured to receive the mechanical vibrations from the transducer, permit the vibration to pass through the surface whilst remaining substantially static, and such that in use the surface generates audible vibrations where the vibrations exit the surface and the surface is positioned proximate to an users ear.

27. The apparatus as claimed in claim 26, further comprising:
a sensor configured to determine a proximate object to the surface.

28. The apparatus as claimed in claim 27, further comprising a controller configured to select the transducer when the sensor determines the proximate object.

29. The apparatus as claimed in claim 28, further comprising a hands free transducer, wherein the controller is configured to select the hands free transducer on the sensor failing to determine the proximate object.

30. The apparatus as claimed in claim 26, wherein the transducer is at least one of:
a linear vibra;
an eccentric mass vibra;
a piezoelectric vibra; and
a moving magnet transducer.

31. The apparatus as claimed in claim 26, wherein the transducer comprises:
a magnet;
a mass coupled to the magnet; and
a coil configured to receive an input to drive the transducer so as to generate the audible vibrations.

32. The apparatus as claimed in claim 31, wherein the transducer further comprises a resilient member coupled to at least one of the magnet and mass, wherein the resilient member is configured to constrain the movement of the magnet and mass in a linear manner.

33. The apparatus as claimed in claim 26, wherein the transducer is coupled to the surface via a direct coupling.

34. The apparatus as claimed in claim 26, wherein the transducer is coupled to the surface via an intermediate coupling configured to transmit the audible vibration from the transducer to the surface.

35. The apparatus as claimed in claim 26, wherein the surface comprises at least one of:
a display panel;
touch screen display panel;
a casing; and
a housing.

36. The apparatus as claimed in claim 35, wherein when the surface comprises the display panel, the transducer is coupled to the display panel substantially along the mid line of the width of the display panel.

37. The apparatus as claimed in claim 36, wherein the transducer is coupled to the display panel substantially to one edge of the length of the display panel.

38. The apparatus as claimed in claim 26, wherein the audible vibrations simulate the functionality of an earpiece module.

39. The apparatus as claimed in claim 26, wherein the transducer is located approximately at the position where the ear of the user is located.

40. The apparatus as claimed in claim 26, wherein the apparatus is configured to determine the difference between an ear and other body part.

41. A method comprising:
mechanically vibrating a transducer; and
coupling a surface to the transducer;
passing the vibration through the surface while the surface remaining substantially static; and
positioning the surface proximate to an users ear so that the surface generates audible vibrations where the vibrations exit the surface.

42. The method as claimed in claim 41, further comprising:
determining a proximate object to the display; and
selecting the transducer to generate mechanical vibrations when the sensor determines the proximate object.

43. The method as claimed in claim 41, wherein the surface comprises at least one of:
a display panel;
touch screen display panel;
a casing; and
a housing.

44. The method as claimed in claim 41, wherein when the surface comprises the display panel, the method comprises coupling the transducer to the display panel substantially along the mid line of the width of the display panel.

45. The method as claimed in claim 44, wherein coupling the transducer to the display panel comprises coupling the transducer to the display panel substantially to one edge of the length of the display panel.
